(19) United States
(12) Patent Application Publication
(10) Pub. No.: US 2025/0144850 A1
(43) Pub. Date: May 8, 2025

(54) METHOD FOR MANUFACTURING COMPLEX COMPOSITE PLUMBING COMPONENTS

(71) Applicant: Kohler Co., Kohler, WI (US)

(72) Inventor: Mark Schibur, Kohler, WI (US)

(21) Appl. No.: 18/937,473

(22) Filed: Nov. 5, 2024

Related U.S. Application Data
(60) Provisional application No. 63/596,607, filed on Nov. 6, 2023.

(51) Int. Cl. B29C 33/38; B29C 39/02; B29C 39/26; B33Y 80/00

(52) U.S. Cl. CPC B29C 33/3842; B29C 39/02; B29C 39/26; B29K 2883/00; B33Y 80/00

(57) ABSTRACT

The present application relates generally to a method for manufacturing complex composite plumbing components. The method includes the production of a printed mold assembly, casting a silicone sleeve within the printed mold assembly, removing an interior core from the silicone sleeve and reassembling the printed mold with the silicone sleeve situated inside an interior cavity, and then casting the desired composite plumbing component within the silicone sleeve.

### CROSS-REFERENCE TO RELATED APPLICATION

The present disclosure claims the benefit of U.S. Provisional Application No. 63/596,607, filed Nov. 6, 2023, which is hereby fully incorporated by reference in its entirety.

### TECHNICAL FIELD

Examples relate generally to the field of methods of manufacturing composite components, and more specifically to methods of manufacturing complex, aesthetically particular composite plumbing components.

### BACKGROUND

Injection molding is a common manufacturing process used to efficiently manufacture parts for use in many different industries. In injection molding, heated material is injected into a mold, where it hardens into the desired shape of the part as it cools. The molds generally comprise two halves that are held together when the material is injected and separated to eject the finished part. Injection molded parts must be designed with the molding process in mind. For example, industrial designers must consider where a parting line will occur on an injection molded part during the design process. Parting lines occur on injection molded parts along the line where the two halves of the mold meet, and the location of a parting line in relation to other features must be considered in order to optimize easy ejection. Parting lines can also affect the aesthetic appeal of molded parts, which can be a critical consideration in highly aesthetic parts. These molds make designing complex parts for the injection molding process extremely difficult or altogether impossible. There is a need for a manufacturing process that avoids the appearance and design challenges of injection molded parts.

### SUMMARY OF THE DISCLOSURE

An example of the present disclosure relates to a method for manufacturing parts without the design restrictions or the parting lines common to the injection molding process. The parts can comprise, but are not limited to, plumbing fixtures, faucets, sink basis, sink aprons, sink systems, bathtubs, showers, toilets, or any of a variety of molded parts.

First, a printed mold assembly is produced using a suitable method, such as three-dimensional (3D) printing. The printed mold assembly can comprise at least two parts: an exterior shell and an interior core.

If desired, a texture can be applied to an interior surface of the exterior shell and/or an exterior surface of the interior core. The texture can be painted, roughened, or otherwise applied.

Next, liquid silicone is fed, injected, or poured into the mold between the exterior shell and interior core, and allowed to cool, forming a silicone sleeve. Once cooled, the molded silicone sleeve is removed, along with the interior core.

The molded silicone sleeve is then reinserted into the exterior shell. After the printed mold assembly is sealed again, a desired composite material or other material for the final part to be molded is fed into the mold. Once sufficiently cooled, the exterior shell can be removed, exposing the silicone sleeve and the molded part. The molded part can be allowed to cool completely before removing the silicone sleeve, exposing the molded part.

Advantageously, this method of manufacturing has few design limitations and creates a part with no parting lines. While the exterior shell may be two or more joined pieces, the silicone sleeve protects the molded part from the parting line of the exterior shell. This enables industrial designers to design complex parts without concern for the mechanical and aesthetic constraints of injection molding.

### BRIEF DESCRIPTION OF THE DRAWINGS

The invention may be more completely understood in consideration of the following detailed description of embodiments of the invention in connection with the accompanying drawing, in which:

FIG. 1 is an exploded view of an example of a method of manufacturing complex composite plumbing components.

FIG. 2 is a flow chart of an example of a method of manufacturing a silicone sleeve.

FIG. 3 is a flow chart of an example of a method of manufacturing a complex composite plumbing component.

### DETAILED DESCRIPTION

According to an example, a method for manufacturing complex composite plumbing components comprises: producing a printed mold assembly, filling the printed mold assembly with silicone to form a silicone sleeve, removing the silicone sleeve from the interior core and returning the silicone sleeve to the exterior shell, filling the silicone sleeve with a desired composite material, allowing the material cool or cure, and removing the casted composite component from the printed mold assembly.

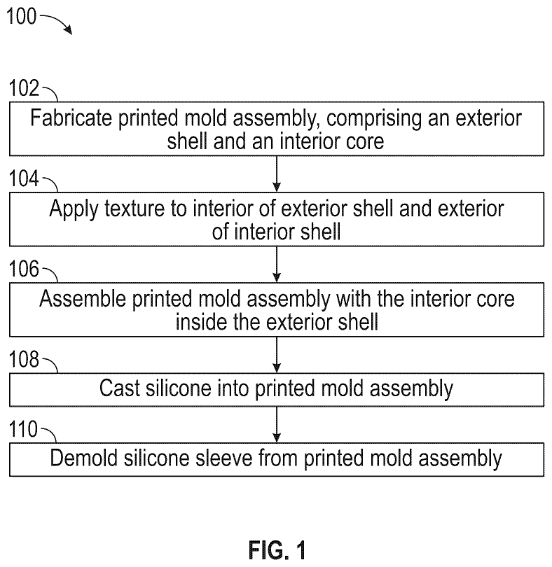

FIG. 1. demonstrates each step of method 100 for manufacturing a silicone sleeve, the precursor to manufacturing a complex composite plumbing part. A printed mold assembly can comprise two distinct components: an exterior shell and an interior core. In 102, the printed mold assembly is manufactured by any suitable method, including 3D printing. 3D printing may be a desirable method because there are few limitations to the types of part designs that are suitable to 3D printing. Further, 3D printing utilizes file types that can be cohesive with the types of files utilized by industrial designers to design parts, streamlining the process of going from ideation to manufactured part. The material of the printed mold assembly can be any suitable material including, but not limited to, thermoplastics.

In 104, both the exterior shell and the interior core can be painted or texturized such that when a silicone sleeve is cast in the printed mold assembly, a texture is transferred to that newly molded silicone sleeve. The interior surface of the exterior shell and the surface of the interior core can both be texturized to transfer the texture to any molded components.

The exterior shell can comprise at least two parts, such that the pieces form a cavity when together and can be separated. The at least two parts of the exterior shell are configured to be removably fastened together to form a liquid-tight connection. Contemplated fasters include bolts configured to be threaded through a plurality of tapped holes on the exterior shell and secured with a nut, but one of skill in the art would recognize that there may be other suitable methods to achieve the desired seal between the at least two pieces of the exterior shell. The interior core is configured to sit within the exterior shell. When combined, the exterior shell and the interior core define a cavity within the printed mold assembly. In 106, the exterior shell pieces are fastened together with the interior core inside.

Then, in 108, silicone can be fed into the cavity defined by the exterior shell and the interior core. The silicone can then be left to solidify into the silicone sleeve as it cools to ambient temperature. After the silicone sleeve has sufficiently cooled, in 110, the silicone sleeve is demolded from the printed mold assembly by uncoupling the at least two pieces of the exterior shell and removing the interior core from the cast silicone sleeve.

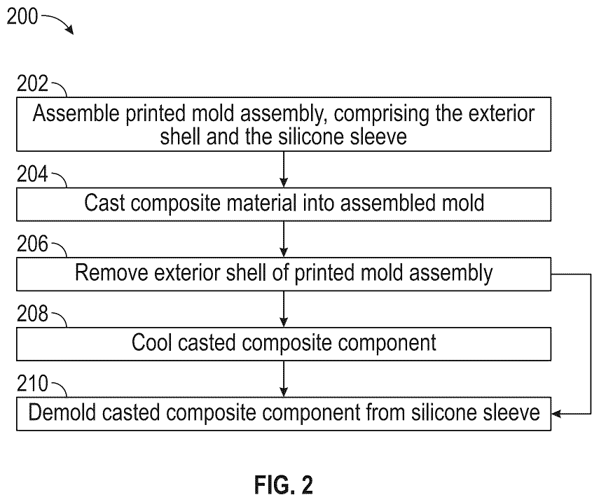

FIG. 2 demonstrates each step of method 200 for manufacturing a complex composite plumbing component. Once the silicone sleeve has been cast, as in method 100, the user can assemble the printed mold assembly again, in order to cast the desired complex composite plumbing component. In 202, the printed mold assembly is assembled with the silicone sleeve situated within the exterior shell pieces, forming a cavity defining the desired composite part. The interior core of method 100 can be excluded from this step of method 200. The exterior shell pieces can be fastened prior to casting the desired composite component in the same or similar fashion described supra.

In 204, after the exterior shell pieces are fastened with the silicone sleeve situated inside, the desired material for the composite component is fed into the assembled printed mold assembly. Then, in 206, the exterior shell of the printed mold assembly is unfastened from the silicone sleeve and the cast composite component. If necessary, in 208, the composite component can be left to cool completely in the silicone sleeve. Whether 208 is necessary may depend on the material properties of the composite material used or other variables. Once the component is sufficiently cooled, it is demolded from the silicone sleeve in 210. Alternatively, the composite component is removed from the silicone sleeve in 210 immediately or shortly after the exterior shell is removed in 206.

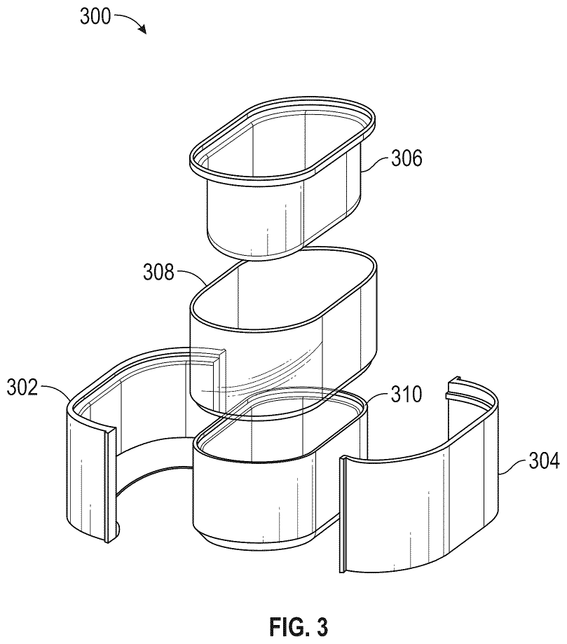

FIG. 3 demonstrates an example of the methods described supra. A printed mold assembly 300 comprises a first exterior shell piece 302 and a second exterior shell piece 304, and an interior core 306. The first exterior shell piece 302 and the second exterior shell piece 304 are configured to fasten together with the interior core 306 situated in the cavity formed. A silicone sleeve 308 can be cast in the cavity formed by the assembled printed mold assembly 308. Once the silicone sleeve 308 has been cast, the silicone sleeve 308 can be assembled with the first exterior shell piece 302 and the second exterior shell piece 304, in order to cast the composite component 310.

This method of manufacturing is advantageous because it enables the manufacturing of complex or highly aesthetic parts without the technical restrictions of injection molding or the inherent cosmetic flaws associated with injection molded composite components. Further, the silicone sleeve is advantageous over simply 3D printed components because the texture of the surface of the desired components can be more controlled. It is contemplated that this method of manufacturing is suitable for manufacturing composite plumbing components, but one of skill in the art may recognize that this method of manufacturing is suitable for manufacturing composite components in other fields.

The disclosure may be embodied in other specific forms without departing from the essential attributes; therefore, the illustrated examples should be considered illustrative and not restrictive in all respects. The claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed:

1. A method of manufacturing at least one complex plumbing component, the method comprising:
providing a mold, the mold comprising an exterior shell and an interior sleeve, wherein the exterior shell comprises at least two connectable components, wherein the interior sleeve comprises an elastomeric material, and wherein the at least two connectable components of the exterior shell are configured to removably encircle the interior sleeve such that a cavity is defined;
heating a moldable material to a temperature sufficient to bring the moldable material into a liquid state;
filling the cavity of the assembled mold with the liquid moldable material;
removing the at least two connectable components of the exterior shell from around the filled cavity; and
removing the interior sleeve.

2. The method of manufacturing at least one complex plumbing component of claim 1, wherein the interior surface of the exterior shell and the exterior surface of the interior sleeve are texturized such that the manufactured plumbing component further comprises a texturized surface.

3. The method of manufacturing at least one complex plumbing component of claim 1, wherein the exterior sleeve of the mold is manufactured by a three-dimensional printing process.

4. The method of manufacturing at least one complex plumbing component of claim 1, the method further comprising cooling the filled cavity such that the moldable material is in a solid state.

5. The method of manufacturing at least one complex component of claim 1, wherein the elastomeric material is silicone.

6. The method of manufacturing at least one complex component of claim 1, wherein the moldable material is selected from the list of: thermoplastic, composite, and resin.

7. The method of manufacturing at least one complex component of claim 1, wherein the exterior shell further comprises at least one fastener configured to fasten the at least two connectable pieces in a liquid tight seal.

8. A method of manufacturing a mold for at least one complex plumbing component, the method comprising:
providing a design for a complex plumbing component;
rendering a model of the complex plumbing component in a software program;
rendering a model of a mold of an elastomeric sleeve in a software program, the elastomeric sleeve comprising the design of the complex plumbing component and the mold of the elastomeric sleeve comprising at least one exterior shell and one interior core;
producing the mold of the elastomeric sleeve;
molding the elastomeric sleeve; and
assembling the mold for the complex plumbing component, the mold comprising the exterior shell of the mold of the elastomeric sleeve and the elastomeric sleeve, wherein the exterior shell and the elastomeric sleeve define a cavity and wherein the cavity comprises the complex plumbing component.

9. The method of manufacturing a mold for at least one complex plumbing component of claim 8, wherein the interior surface of the exterior shell and the exterior surface of the interior core are texturized.

10. The method of manufacturing at least one complex component of claim 8, wherein the elastomeric sleeve is silicone.

11. The method of manufacturing a mold of at least one complex component of claim 8, wherein the exterior shell further comprises at least two removably connected components.

12. The method of manufacturing a mold of at least one complex component of claim 9, wherein the exterior shell further comprises at least one fastener configured such that the exterior shell is liquid tight.

13. A method of manufacturing a complex plumbing component, the method comprising:
providing a sleeve mold to be used for molding the pluming component, the sleeve mold comprising a first shell and a second shell;
assembling the sleeve mold, wherein the second shell is configured to fit within the first shell and wherein the first shell and the second shell together define a cavity;
heating a first material such the material is in a liquid state;
injecting the first material in the cavity defined by the first shell and the second shell, wherein the cavity comprises a molded sleeve; and
disassembling the sleeve mold.

14. The method of claim 13, further comprising:
assembling a mold of a plumbing component, the mold comprising, the first shell and the molded sleeve, such that the first shell and the molded sleeve define a cavity comprising the plumbing component;
heating a second material such that the second material is in a liquid state;
pouring the second material into the cavity defined by the first shell and the molded sleeve;
removing the first shell; and
removing the molded sleeve.

15. The method of manufacturing the complex plumbing component of claim 14, wherein the first material is silicone.

16. The method of manufacturing the complex plumbing component of claim 14, wherein the second material comprises a thermoplastic material, a composite material, a resin, or combinations thereof.

17. The method of manufacturing the complex plumbing component of claim 13, wherein the first shell and the second shell of the sleeve mold are produced via three-dimensional printing.

18. The method of manufacturing the complex plumbing component of claim 13, wherein an interior of the first shell and an exterior of the second shell have a texturized surface.

19. The method of manufacturing the complex plumbing component of claim 13, wherein the first shell further comprises at least two removably attached components.

20. The method of manufacturing the complex plumbing component of claim 13, wherein the first shell further comprises at least one fastener configured such that the first shell is liquid tight.
